(19) United States
(12) Patent Application Publication
(10) Pub. No.: US 2021/0229533 A1
(43) Pub. Date: Jul. 29, 2021

(54) Removable Sun Visor for Car Windows

(71) Applicant: Ararat Yousefi, Glendale, CA (US)

(72) Inventor: Ararat Yousefi, Glendale, CA (US)

(21) Appl. No.: 17/153,047

(22) Filed: Jan. 20, 2021

Related U.S. Application Data
(60) Provisional application No. 62/966,343, filed on Jan. 27, 2020.

(51) Int. Cl. B60J 3/00

(52) U.S. Cl. CPC B60J 3/005

(57) ABSTRACT

Improvements in a removable sun visor for car windows is disclosed. The visor uses a rotatable and removable window clip so the user can install and move the visor when needed to block or filter sunlight from entering the vehicle. The clip can also be rotated and locked on an angled side of a window to block or filter light that can enter the vehicle from a far forward edge. The rotating feature has locks or detents to hold the visor at the adjusted angle. The rotatable clip can further be positioned on either side of the visor for positioning on either side of a vehicle. There is also an adjustable tinted window that allows the user to look through the tinted portion. Side portions can be moved in or out of the main housing to block light. Magnets can be used to secure moving members.

### CROSS REFERENCE TO RELATED APPLICATION

This application claims the benefit of Provisional Application Ser. No. 62/966,343 filed Jan. 27, 2020 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in a sun visor. More particularly, the present removable sun visor for car windows creates a visor that can be installed and removed from a side window of a car to block or filter sun from shining within the car or vehicle.

### Description of Related Art Including Information Disclosed Under 37 CFR 1.97 and 1.98

For many drivers and passengers in cars, trucks or vehicle the setting sun, rising sun or even hot days the sun can make driving difficult or uncomfortable. For the driver and passenger, the from sun visor can be positioned to block some of the light from the sun. This integrated visor provides little or no use to the rear passengers, and because the visor is mostly intended for use with the front window the shape of the visor makes it difficult to block the sun from the curves contour of the side windows.

A number of patents and or publications have been made to address these issues. Exemplary examples of patents and or publication that try to address this/these problem(s) are identified and discussed below.

U.S. Pat. No. 5,683,293 issued on Nov. 4, 1997 to Gaffar Mohammed and is titled Combined Vent and Glare Screen Unit for Vehicle Windows. This patent discloses a ventilator-glare screen unit adapted to be fit in an automotive window opening, having controllably opened vent hole groupings and an inner glare screen able to be moved from a raised to a lowered position. A wedge-shaped extension piece attached to a forward edge is fit to an angled front window glass edge. A slidable control panel allows different vent hole groupings to be opened or blocked. A hood minimizes entry of rain, etc. into the opened vent holes. While this patent discloses a glare screen, the glare screen does not allow for the glare screen to be slide to the curved area of a side window.

U.S. Patent publication Number 2003/0214147 was published on Nov. 20, 2003 to Debbie Mashburn and is titled Dual Purpose Vehicle Shade. This published application discloses a shade that is made with a thin piece of resin plastic, which folds at the top. At the fold this shade attaches to the top of the either the driver side or passenger side car door either outside or inside the vehicle, whichever position gives the shade a more airtight fit. The shade can also be attached to the front windshield's sun visor on either the driver side or passenger side. This shade facilitates protection from the sun on the user's face when attached to side window. It also facilitates reduction in sun glare when it is attached to the front windshield's sun visor. It is treated with UV stabilizer which prevents ultraviolet (UV) rays from passing there through. This shade is just a fixed “J” shaped piece of plastic and has no adjustable components.

U.S. Pat. No. 7,131,683 issued on Nov. 7, 2006 to Jing-Shuong Gong and is titled Shade Assembly for Automobile Window. This patent discloses a shade assembly includes a plurality of fastening blocks and a shade with a flexible frame. Each of the plurality of the fastening blocks is adhered onto a top edge or a bottom edge of a window frame of an automobile and has a lengthwise groove with a narrower opening for receiving the shade. Thus, the shade doesn't need to be removed when lifting or lowering the side window. Further, the shade can be easily removed because of the flexible frame. The shade has a fixed size and covers the entire side window.

U.S. Pat. No. 10,675,953 issued on Jun. 9, 2020 to Luis H. Serentill et al., and is titled Side Window Visor, A Method of Installation, and a Motor Vehicle Having a Side Window Visor. This patent discloses a side window visor designed to attach to a vehicle window channel. The side window visor can be arranged and configured to extend over a portion of a window area for preventing inclement weather from entering the passenger cabin with the window slightly opened. A full length tab is reduced to form a plurality of tabs along the tab area of a side window visor. The plurality of tabs located on the side window visor allows the auto-up window feature to be used without causing large resistance and retraction of the window. While the visor is securable to a side window is essentially a curved plastic part that does not allow the user to adjust the size or position to filter or block sunlight.

What is needed is a sun visor that can be easily installed and removed and further has a number of sliding and/or hinged elements that allows the visor to accommodate most side windows. The removable sun visor for car windows disclosed in this document provides the solution.

### BRIEF SUMMARY OF THE INVENTION

It is an object of the removable sun visor for car windows for the visor to be removable so the user can install the visor when needed and can move the visor to other windows as needed to block or filter sunlight from entering the vehicle. The visor has a clip for securing the visor on a side window and can be easily slide fore or aft to locate the visor in an optimal location along the side window. When not needed the visor can be easily removed for storage. The visor is on a hinged connection to the clip so the visor can be rotated over a portion of the window, can be partially rotated or rotated into the roof or to the headliner of a vehicle.

It is an object of the removable sun visor for car windows to have a rotatable clip that secures the visor to a side window. The rotatable clip allows the angle of the visor to be adjusted. This further allows the visor to be positioned on an angled side of a window to block or filter light that can enter the vehicle from a far forward edge. The rotating feature has locks or detents to hold the visor at the adjusted angle. The rotatable clip can further be positioned on either side of the visor for positioning on the driver or passenger side of a vehicle.

It is an object of the removable sun visor for car windows to have side sliding members. The sliding members reduces the compacted width of the visor. The sliding members are shaped to match angled or radiused corners of a window to fill the corners or edges of a window. A lock or stop prevents a user from completely removing or sliding the side members or of the main housing. In another embodiment one of the members can be rotated into or out of the main housing.

It is an object of the removable sun visor for car windows to have a tinted polycarbonate window. The tinted polycarbonate window allows the user to look through the tinted polycarbonate window and out of the vehicle window to filter some of the outside light without completely blocking vision out of the vehicle. The tinted polycarbonate window can hinge or slide from the main housing as needed or desired.

It is another object of the removable sun visor for car windows to have a padded and or fabric covered portion to cover the internal mechanism with a lightweight and soft surface that can match a surface or appearance of the vehicle. The fabric can be stretched over the internal frame.

It is still another object of the removable sun visor for car windows to use a magnetic or a flexible clasp that can hold any doors or moving members closed. The also prevents movement of the components based upon vibration or bumps that can be experienced by the vehicle as the vehicle is driven over uneven roads, acceleration, deceleration and around turns.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a side view of a removable sun visor on a window of a vehicle.

FIG. 2 shows the removable sun visor in a closed embodiment in a raised and lowered configuration.

FIG. 3 shows the removable sun visor in an open configuration.

FIG. 4 shows the removable sun visor with the fabric covering removed.

FIG. 5 shows an exploded view of the removable sun visor.

FIG. 6 shows the window clip of the removable sun visor.

FIG. 7 shows a first detail view of the window clip rotation mechanism.

FIG. 8 shows a second detail view of the window clip rotation mechanism.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

Item Numbers and Description

| | |
|---|---|
| 10 removable sun visor | 18 vehicle |
| 19 window | 20 inner frame |
| 21 open area | 22 hole |
| 23 post | 24 rotated body |
| 30 chipboard pad | 31 magnet hole |
| 32 magnet | 34 chipboard pad |
| 38 fabric cover | 40 foam pad |
| 41 magnet hole | 42 magnet |
| 49 inside position | 50 large sliding shade |
| 51 finger tab | 52 lock tab (upper) |
| 53 lock tab (lower) | 54 curved edge |
| 60 small shade | 61 pivot hole |
| 62 finger tab | 70 tinted flap |
| 71 magnet recess | 72 tab |
| 73 hook | 74 magnet |
| 80 window clip | 81 hinge pin hole |
| 82 clip | 83 open area |
| 86 nut | 87 hinge |
| 88 screw | 89 hinge pin |
| 90 hinge pivot | 91 shoulder |
| 92 groves | 93 tabs |
| 96 detent rotation | 97 lowered |
| 98 rotate | 99 moves |

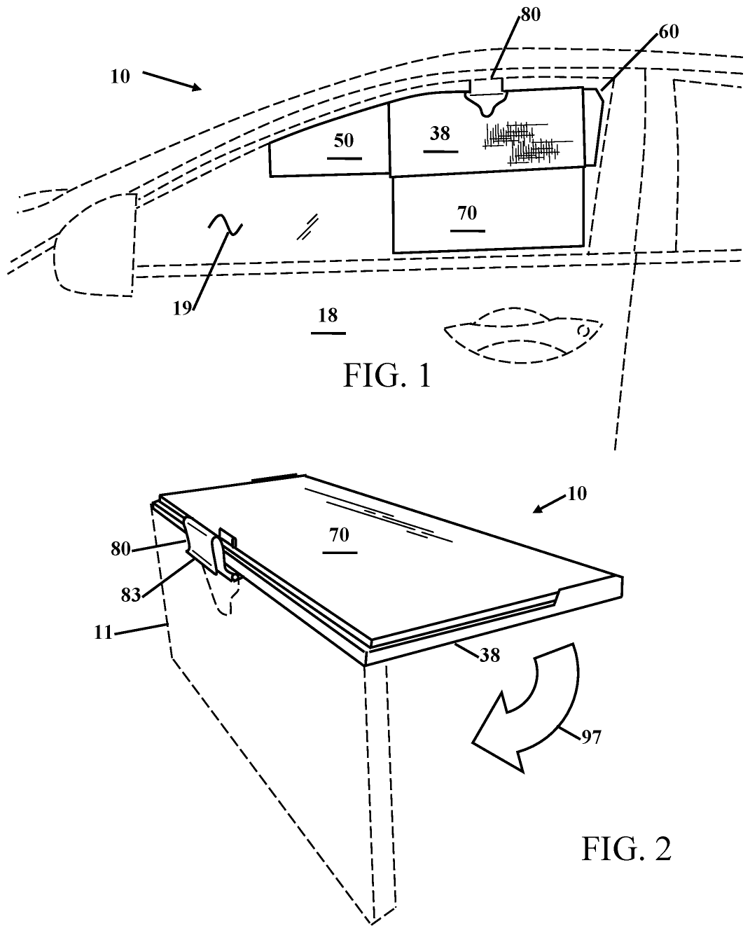

FIG. 1 shows a side view of a removable sun visor 10 on a window 19 of a vehicle 18. In this embodiment the fabric cover 38 over an inner frame. A window clip 80 is shown securing the removable sun visor 10 onto the window 19. In this figure, the removable sun visor 10 is shown completely expanded with a large sliding shade 50, a small sliding shade 60 and a tinted flap 70. The large sliding shade 50 and the small sliding shade 60 are shaped to fill a space along edges of the window 19. This figure provides a general overview of the removable sun visor 10 installed on a vehicle 18 window 19.

FIG. 2 shows the removable sun visor 10 in a closed embodiment in a raised and lowered 11 configuration. The window vehicle is not shown in this figure for clarity. The window clip 80 is configured to wrap around the window in the open area 83 of the window clip 80. The window clip 80 has a hinge that allows the removable sun visor 10 to hold at least a lowered 97 position where it can block or filter light and a raised position (shown in solid line) where it does not obstruct view out the window. There is a tinted flap 70 that is shown folded onto the fabric covering 38 of the inner frame 20. In this compacted configuration, the removable sun visor 10 fits in the headliner area of the vehicle. The window clip 80 fits over the top of the vehicle window and allows the window to be raised and lowered as the removable sun visor 10 is carried with the opening and closing window. The window clip 80 allows the removable sun visor 10 to be slid or moved along the window to locate the removable sun visor 10 at an optimal position to block undesired sun with or without unfolding, swinging or sliding panels from within the frame.

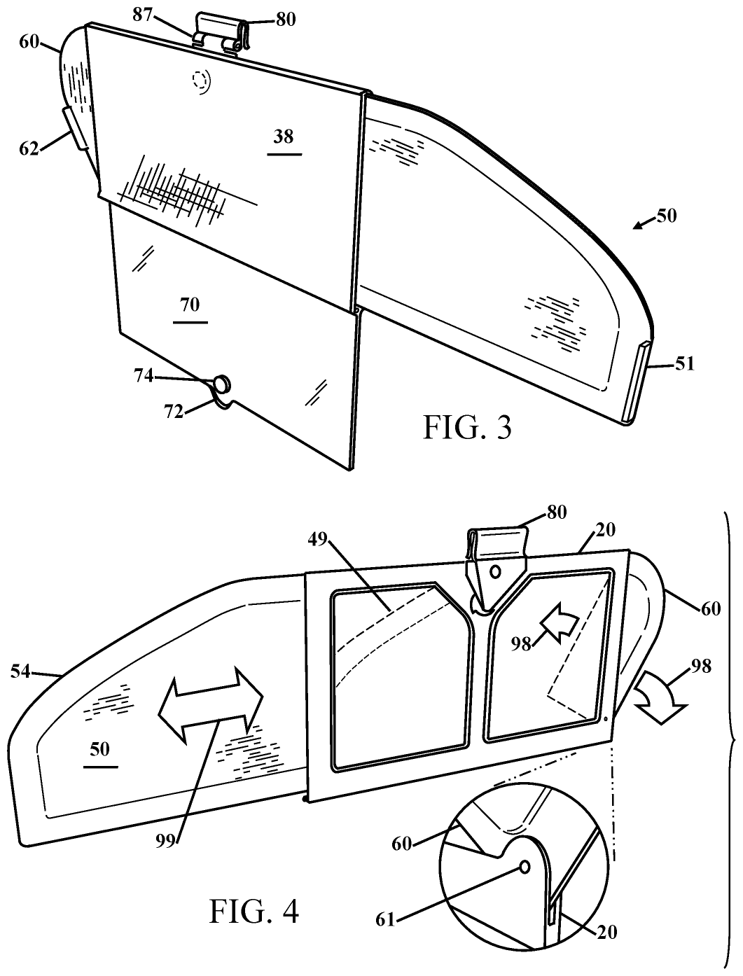

FIG. 3 shows the removable sun visor 10 in an open configuration. This configuration is what a user would see from the inside of a vehicle with the panels expanded. The window clip 80 is placed over the top of a window where a portion of the window clip 80 would be outside of the vehicle and a portion would be inside of the vehicle. The hinge 87 allows the removable sun visor 10 to be rotate to a position over a vehicle window to a position in the headliner area of a vehicle. The fabric cover 38 covers the inner frame 20 that is shown in other figure herein. On one side of the fabric cover 38 and inner frame 20, is the small sliding shade 60.

A finger tab 62 allows the user to grasp and edge or corner of the small sliding shade 60 to slide (or rotate) the small shade from within the fabric cover and small shade 60. The larger sliding shade 50 stores with the fabric cover 38 and can be slid out of the fabric cover 38. A finger tab 51 allows the user to easily slide the larger sliding shade 50 in and out of the inner frame. At the lower portion of this figure shows the tinted flap 70. The tinted flap 70 hinges (or slides from the inner frame). In the embodiment shown, the tinted flap 70 has a tab 72 that makes it easier for a user to find grip point on the tinted flap 70. A magnet 74 is used to retain the tinted flap 70. The tinted flap 70 allows the user to view through the tinted flap 70 without completely obstructing a view outside of the window of a vehicle.

FIG. 4 shows the removable sun visor with the fabric covering removed. The window clip 80 is shown mounted to the top of the inner frame 20. In this view, the internal structure of the removable sun visor 10 is shown. The larger sliding shade 50 is shown extended and in a stored inside position 49 with broken lines. The larger sliding shade 50 is formed with a recess that reduces the amount of material in the larger sliding section and reduces the weight of the removable sun visor 10. The larger sliding shade 50 is able to move 99 in and out of the inner frame 20. At the other side of the inner frame 20 is the small shade 60.

This embodiment shows that the small shade 60 is configured to rotate 98 out of the inner frame 20. The detail shows a pivot hope 61 where the small shade 60 is captured in the inner frame 20. This allows the small shade to rotate within and out of the inner frame. While the large sliding shade 50 and the small shade 60 may be shown as having a solid (non-transparent) material it is contemplated that one or both of these shades can be made from a transparent or filtered material.

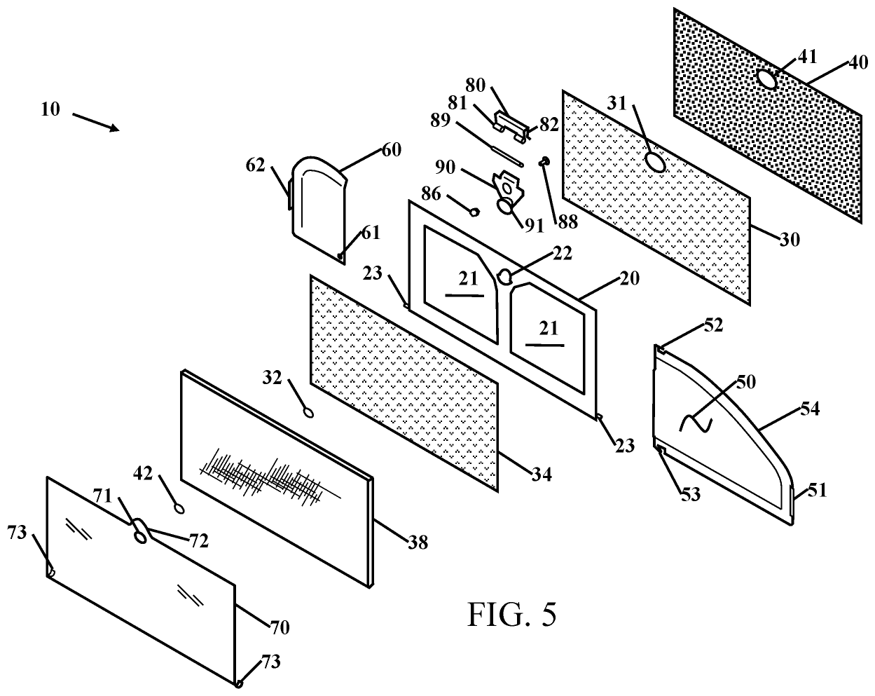

FIG. 5 shows an exploded view of the removable sun visor 10. While this figure shows a particular embodiment, it should be understood that other variations to the connections to the components are contemplated. Starting with the inner frame 20 where the other components connect to or expand from. The inner frame 20 is shown as having open areas 21 to reduce the weight of the inner frame 21 without compromising the structure or function of the removable sun shade 10. Near the middle of the inner frame 20 is a hole 22 for securing the hinge pivot 90. On the bottom ends of the inner frame are posts 23 for connection with hooks 73 on the tinted flap 70.

The hooks 73 on the tinted flap 70 allow the tinted flap to be easily hinged or rotated down for light filtering or rotated up onto the inner frame for storage. The tinted flap filters some light and allows a user to view outside of a vehicle. At the upper end of the tinted flap 70 is a tab 72 and a magnet recess 71 or metal components that attracts to a magnet 42. A complementary magnet 32 is located in or on the inner frame to holt the tinted flap 70 in the closed configuration under driving conditions. It is contemplated that the tinted flap 70 can be interchangeable to allow a user to select the amount of filtering based upon the season or the expected amount of sunlight.

Returning to the hole 22 in the inner frame 20, the shape of the hole 22 is configured to accept the hinge pivot 90 where a shoulder 91 of the hinge pivot 90 is configured to pass through the hole 22 from either side of the inner frame 20. The hinge pivot 90 can pass through either side to allow the removable sun visor 10 to be installed on either the passage or the driver side of a vehicle. A screw 88 and nut 86 are removable to change the direction where the hinge pivot 90 passes through the inner frame 20. The hole 22 is not completely round and is shaped to limit rotation of the shoulder 91 in the hole 22. This is shown and described in more detail in other figures herein. At the top of the hinge pivot 90 is a horizontal hole where a hinge pin 89 passes through the hinge pin hole(s) 81 and the hinge pivot 90. At the top of the hinge pin hole(s) 81 is the window clip 80 with an open clip 82 tab for securing the window clip 80 on a window (not shown).

The outside of the inner frame 20 can be covered with one or more of a chipboard pad 30, 34 shim(s), a foam pad 40 and a fabric covering 38. Magnet holes 31 and 41 may be placed through some of these components for clearance of magnets 32, 42 or metal components to keep the tinted flap 70 is a closed orientation. The inner frame is shown with a small shade 60 and a large shade 50. While two side shades are shown and described, the removable sun visor may have only one side shade or more than the two shown to provide additional versatility to contour to the windows or more different vehicles.

The small shade 60 can hinge or slide from within the inner frame 20. In the hinged configuration the small shade 60 pivots from the pivot hole 61. There is a finger tab 62 that a user can access to grip and move the small shade 60. On the other side of the inner frame 20 is the large shade 60 that is configured to slide in and out of the inner frame 20. The large shade 60 has a curved edge 54 that approximates the curve of a side window to block sun in the corners of a door window. The side end of the large shade 60 has one or a plurality of tab locks 52 and 53 that prevent the large shade 60 from being completely slid out of the inner frame 20. There is a finger tab 51 that a user can access to grip and slide the large shade 50 out of the inner frame 20.

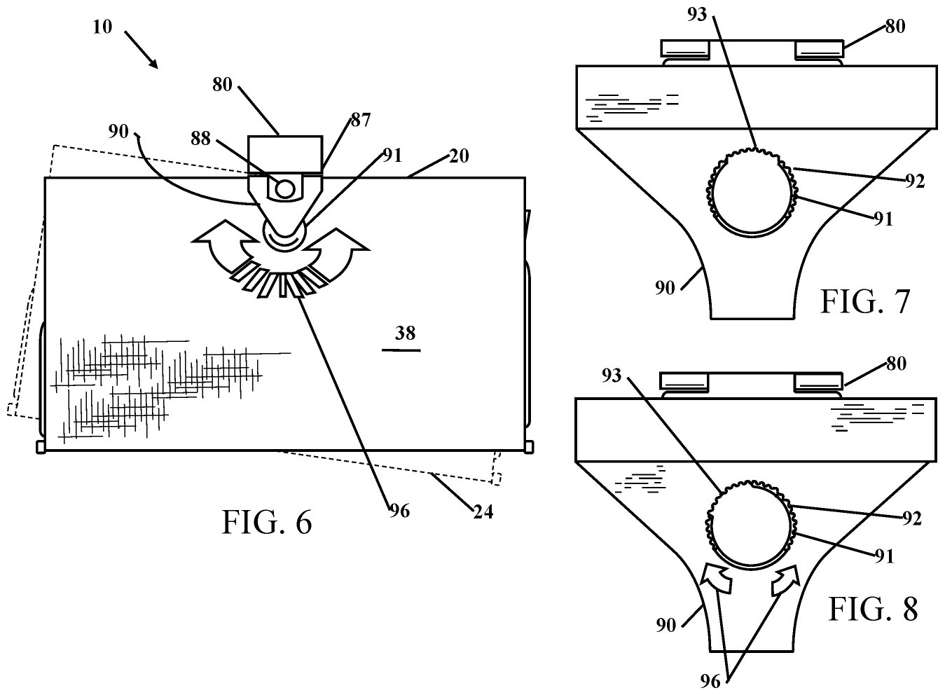

FIG. 6 shows the window clip of the removable sun visor 20 with the fabric cover 38 over the removable sun visor 20. In plan view of FIG. 6 the window clip 80 extends above the hinge pivot 90 with the screw 88 securing the hinge pivot 90 to the window clip 80. The shoulder of 91 the hinge pivot passes through the body of the visor. The hinge 87 passes parallel to the body of the visor. The broken lines show the body of the visor in as a rotated body 24. The body of the visor can be rotated in steps as a detent rotation 96. The steps of the detents are shown in the following figures.

FIG. 7 shows a first detail view of the window clip rotation mechanism and FIG. 8 shows a second detail view of the window clip rotation mechanism. In these figures the body of the visor is removed for clarity with mostly the components related to the hinge pivot 90 and the window clip 80. The window clip 80 has been rotated away in these views. The rotation of the body of the visor is perpendicular to the rotation of the hinge on the window clip 80.

The shoulder 91 of the hinge pivot 90 has a plurality of tabs 93 that engage in groves 92. As the visor (not shown) rotates relative to the hinge pivot 90 the tabs 93 engage and dis-engage in the groves 92 to create rotational locking detent rotation 96 positions to hold the visor in the set rotated position. While groves 92 and tabs 93 are shown and described, frictional elements could also be provided to allow for more infinite positioning. The shape of the hole 22 (not completely visible in this figure) limits rotation of the body of the visor relative to the hinge pivot 90 by eliminating the groves at a portion of the shoulder, as seen at the bottom of the shoulder 91.

Thus, specific embodiments of a removable sun visor for car windows have been disclosed. It should be apparent, however, to those skilled in the art that many more modifications besides those described are possible without departing from the inventive concepts herein. The inventive subject matter, therefore, is not to be restricted except in the spirit of the appended claims.

### SEQUENCE LISTING

Not Applicable.

1. A removable sun visor for car windows comprising:
a clip that is configured to slidably secure the removable sun visor on a vehicle side window;
said clip connects with a hinge to a hinge pivot that is configured to allow a body of a sun visor to rotate adjacent to said vehicle side window and adjacent to a headliner of said vehicle;
said hinge pivot being connected to a rotating shoulder that allows said body of said sun visor to rotate perpendicular to said hinge, and
said body of said sun visor having a first shade that is configured to store within said body of said sun visor and securely slide a limited distance outside of said body of said sun visor.

2. The removable sun visor for car windows according to claim 1, wherein said first shade has at least one curved upper edge.

3. The removable sun visor for car windows according to claim 2, wherein said first shade further includes at least one lock tab that prevents said first shade to be slid completely outside of said body of said sun visor.

4. The removable sun visor for car windows according to claim 3, wherein said first shade further includes finger tab located on an outer edge of said first shade.

5. The removable sun visor for car windows according to claim 1, further includes a at least a second shade.

6. The removable sun visor for car windows according to claim 5, wherein said second shade is configured to slide out of said body of said sun visor.

7. The removable sun visor for car windows according to claim 5, wherein said second shade is configured to rotate out of said body of said sun visor through a pivot connection with said body.

8. The removable sun visor for car windows according to claim 5, wherein said second shade further includes finger tab located on an outer edge of said second shade.

9. The removable sun visor for car windows according to claim 1, further includes a tinted flap.

10. The removable sun visor for car windows according to claim 9, wherein said tinted flap is configured to hinge below said body of said sun visor.

11. The removable sun visor for car windows according to claim 9, wherein said tinted flap further includes a magnetic clasp that retain said tinted flap aligned with body of said sun visor.

12. The removable sun visor for car windows according to claim 1, wherein said rotating should has detents that creates locked step rotation of said body of said sun visor relative to said hinge.

13. The removable sun visor for car windows according to claim 12, wherein said detents are from complementary tabs and groves.

14. The removable sun visor for car windows according to claim 13, wherein said tabs and groves limit a rotation of said body of said sun visor.

15. A removable sun visor for car windows comprising:
a visor body;
said visor body having a first shade that is configured to store within said body of said sun visor;
said visor body having a second shade that is configured to store within said body of said sun visor;
said visor body having a tinted flap that is configured to hinge from said body of said sun visor, and
a clip that is configured to secure the visor body on a vehicle side window.

16. The removable sun visor for car windows according to claim 15, wherein said first shade has at least one curved upper edge.

17. The removable sun visor for car windows according to claim 16, wherein said first shade further includes at least one lock tab that prevents said first shade to be slid completely outside of said body of said sun visor.

18. The removable sun visor for car windows according to claim 15, wherein said first shade and said second shade each include a finger tab located on an outer edge of said first shade and said second shade.

19. The removable sun visor for car windows according to claim 15, wherein said second shade is configured to rotate out of said body of said sun visor through a pivot connection with said body.

20. The removable sun visor for car windows according to claim 15, wherein said tinted flap further includes a magnetic clasp that retain said tinted flap aligned with body of said sun visor.
